(19) United States
(12) Patent Application Publication
(10) Pub. No.: US 2019/0028929 A1
(43) Pub. Date: Jan. 24, 2019

(54) DATA-INTERFACE FLOW-SPLITTING METHOD, APPARATUS, TERMINAL DEVICE, AND COMPUTER STORAGE MEDIUM

(71) Applicant: NUBIA TECHNOLOGY CO., LTD., Shenzhen (CN)

(72) Inventor: Xiaodong CHE, Shenzhen (CN)

(73) Assignee: NUBIA TECHNOLOGY CO., LTD., Shenzhen (CN)

(21) Appl. No.: 16/068,477

(22) PCT Filed: Jul. 18, 2016
(86) PCT No.: PCT/CN2016/090339

§ 371 Date: Jul. 6, 2018

(30) Foreign Application Priority Data
Jan. 8, 2016 (CN) 201610013265.4

(51) Int. Cl. H04W 28/10; H04W 24/08; H04W 28/08; H04W 72/12

(52) U.S. Cl. CPC H04W 28/10; H04W 72/1252; H04W 28/08; H04W 24/08

(57) ABSTRACT

The present invention provides a data-interface flow-splitting method, apparatus, and terminal device. The data transmission method includes: detecting, by a first terminal, connectivity of each data interface in real time; after the first terminal detects that data needs to be transmitted, according to an initial splitting weight, allocating a plurality of established links to data interfaces in an ‘UP’ state for data transmission; and during transmission of the data, calculating a real-time splitting weight, and according to the real-time splitting weight, allocating newly established links to data interfaces in the ‘UP’ state for data transmission. The present invention also provides a computer storage medium.

### FIELD OF THE DISCLOSURE

The present disclosure generally relates to the field of communication technology and, more particularly, relates to a data-interface flow-splitting method, apparatus, terminal device, and computer storage medium.

### BACKGROUND

With the development of mobile communication technologies, advanced cellular networks (e.g., networks based on LTE standards (long-term evolution, standards used by some 4G networks)) are being deployed all over the world. Due to the introduction of orthogonal frequency division multiplexing (OFDM), multi-input & multi-output (MIMO), and other key technologies, use of the LTE standards can significantly increase the spectral efficiency and the data transmission speed.

Use of the cellular networks to perform data transmission (e.g., downloading and uploading) for terminals can greatly improve users' online experience. However, with the development of technologies, high-resolution videos, games, and other large-data applications emerge one after another. Use of a single data interface for data transmission cannot meet users' increasing demand for the transmission speed due to the limit of maximum capacity of the data interface.

Therefore, the existing technology has drawbacks and still needs to be improved.

### BRIEF SUMMARY OF THE DISCLOSURE

In view of this, the present invention provides a data-interface flow-splitting method, an apparatus, and a terminal device.

One aspect of the present disclosure includes a data-interface flow-splitting method. The method includes:

detecting connectivity of each data interface;

after detecting that data needs to be transmitted, allocating data flows for data interfaces in an ‘UP’ state according to an initial splitting weight; and

during transmission of the data, adjusting the data flows of the data interfaces according to speed of the data interfaces and a preset splitting rule.

Optionally, the initial splitting weight is 1:1.

Optionally, the data interfaces include at least one WIFI data interface and at least one long-term evolution (LTE) data interface.

Optionally, the preset splitting rule includes:

when speed of both the WIFI data interface and the LTE data interface continue to be lower than a preset speed for a preset time-period, and the splitting weight of the WIFI data interface is greater than a first preset value or lower than a second preset value, adjusting the splitting weight of the WIFI data interface to the first preset value.

Optionally, the preset splitting rule further includes:

when a ratio of an average speed of the WIFI data interface over an overall average speed of the interfaces is greater than the first preset value, adjusting the splitting weight of the WIFI data interface to 1;

when the ratio is less than the second preset value, adjusting the splitting weight of the WIFI data interface to 0; and

when the ratio is less than the first preset value or greater than the second preset value, adjusting the splitting weight of the WIFI data interface to be equal to the ratio.

Optionally, a change in a number of bytes of a data interface is obtained every preset-time-period as a speed of the data interface; and

an average speed of the data interface is a ratio of a sum of the speed of the data interface within preset-time-period over a length of the preset-time-period.

Optionally, an average speed of the data interface is equal to a sum of a last time statistical average speed of the data interface multiplied by a first weight and a current speed of the data interface multiplied by a second weight.

Another aspect of the present disclosure includes a data-interface flow-splitting apparatus, comprising:

a detection unit configured to detect connectivity of each data interface in real time;

an initial allocation unit configured to allocate data flows for data interfaces in an ‘UP’ state according to an initial splitting weight after detecting that data needs to be transmitted; and

an adjustment unit configured to adjust data flows of the data interfaces according to speed of the data interfaces and a preset splitting rule during transmission of the data.

Another aspect of the present disclosure includes a terminal device, comprising:

a plurality of wireless data interfaces; and

a processor, wherein the processor detects connectivity of each data interface, allocates data flows for data interfaces in an ‘UP’ state according to an initial splitting weight after detecting that data needs to be transmitted, and adjusts data flows of the data interfaces according to speed of the data interfaces and a preset splitting rule during transmission of the data.

Optionally, the data interfaces include one WIFI data interface and one LTE data interface; and

the preset splitting rule includes:

when speed of both the WIFI data interface and the LTE data interface continue to be lower than a preset speed for a preset time-period, and the splitting weight of the WIFI data interface is greater than a first preset value or lower than a second preset value, adjusting the splitting weight of the WIFI data interface to the first preset value;

when a ratio of an average speed of the WIFI data interface over an overall average speed of the interfaces is greater than the first preset value, adjusting the splitting weight of the WIFI data interface to 1;

when the ratio is less than the second preset value, adjusting the splitting weight of the WIFI data interface to 0; and

when the ratio is less than the first preset value or greater than the second preset value, adjusting the splitting weight of the WIFI data interface to be equal to the ratio.

Another aspect of the present disclosure includes a data-interface flow-splitting method, comprising:

obtaining speed of data interfaces and a preset splitting rule; and

when performing transmission of data, determining data flows of the data interfaces according to the speed of the data interfaces and the preset splitting rule.

Optionally, the method further including:

obtaining an initial splitting weight of the data interfaces; and

determining data flows of the data interfaces at an initial transmission moment according to the initial splitting weight.

Optionally, when performing transmission of the data, determining the data flows of the data interfaces according to the speed of the data interfaces and the preset splitting rule includes:

calculating a ratio of a current speed of a data interface over a maximum transmission speed of the data interface to obtain a loading ratio; and

according to the loading ratio, adjusting the splitting weight of each data interface to enable a transmission speed of each data interface to be less than the maximum transmission speed.

Optionally, adjusting the splitting weight of each data interface according to the loading ratio includes:

reducing the splitting weight of a data interface having the loading ratio greater than an average loading ratio.

Optionally, adjusting the splitting weight of each data interface according to the loading ratio includes:

increasing the splitting weight of a data interface having the loading ratio less than the average loading ratio.

Optionally, according to the loading ratio, adjusting the splitting weight of each data interface to enable the transmission speed of each data interface to be less than the maximum transmission speed includes:

obtaining preset parameters for characterizing transmission priority of each data interface;

determining adjustment thresholds according to the preset parameters, wherein a data interface with a different priority parameter has a different adjustment threshold;

obtaining a comparison result by comparing the loading ratio and the adjustment threshold; and

adjusting the splitting weight of each data interface according to the comparison result.

Optionally, obtaining the preset parameters for characterizing the transmission priority of each data interface includes:

obtaining interface-type parameters of each data interface;

determining the adjustment thresholds according to the preset parameters includes:

determining the adjustment thresholds according to the interface-type parameters; and

adjusting the splitting weight of each data interface according to the comparison result includes:

when the loading ratio is greater than the adjustment threshold, reducing the splitting weight of the corresponding data interface.

Optionally, obtaining the preset parameters for characterizing the transmission priority of each data interface includes:

obtaining tariff parameters of each data interface; and

determining the adjustment thresholds according to the preset parameters includes: determining the adjustment thresholds according to the tariff parameters.

Optionally, a tariff parameter representing the tariff per unit data flow is inversely proportional to an adjustment threshold.

Another aspect of the present disclosure includes a computer storage medium, comprising: computer-executable instructions stored in the computer storage medium, wherein the computer-executable instructions are used to execute a method according to any one of claims 1-7 and claims 11-19.

Through the data-interface flow-splitting method, apparatus, the terminal device and the computer storage medium in the disclosed embodiments of the present invention, a plurality of data interfaces may be simultaneously used to transmit data, which may greatly optimize the allocation ratio of the data flow. Because the speed may reflect a bandwidth size of the interface to a certain extent, the interface with a larger bandwidth may carry more data. Therefore, a large amount of data may not be likely to be transmitted through the interface with a small bandwidth, such that the issues of congestion of the interface with the small bandwidth, large delay, and packet loss may be avoided, improving user experience. Flow-splitting based on the speed of the interfaces and the preset splitting rule may optimize the allocation efficiency and improve data-interface utilization rate. At the same time, the setting of the preset splitting rule may allow the WIFI data interface to be preferentially used to save costs for users and to improve user experience.

### BRIEF DESCRIPTION OF THE DRAWINGS

The present invention is further described below with reference to the accompanying drawings and embodiments. In the drawings:

FIG. 1 illustrates a schematic structural diagram of a terminal consistent with disclosed embodiments of the present invention;

FIG. 2 illustrates an architecture diagram of an operating system consistent with disclosed embodiments of the present invention;

FIG. 3 illustrates a schematic diagram of a network architecture consistent with disclosed embodiments of the present invention;

FIG. 4 illustrates a schematic flowchart of data-interface flow-splitting consistent with disclosed embodiments of the present invention;

FIG. 5 illustrates a schematic flowchart of detecting connectivity of an interface consistent with disclosed embodiments of the present invention;

FIG. 6 illustrates a schematic flowchart of marking data packets consistent with disclosed embodiments of the present invention;

FIG. 7 illustrates a schematic flowchart of a data-interface flow-splitting method consistent with disclosed embodiments of the present invention; and

FIG. 8 illustrates a schematic flowchart of another data-interface flow-splitting consistent with disclosed embodiments of the present invention.

### DETAILED DESCRIPTION

For clearer understanding of the technical characteristics, aims and effects of the present invention, specific embodiments of the present invention are now described in detail with reference to the accompanying drawings. It should be understood that the preferred embodiments described below are merely used to illustrate and explain the present invention, and do not limit the scope of the present invention.

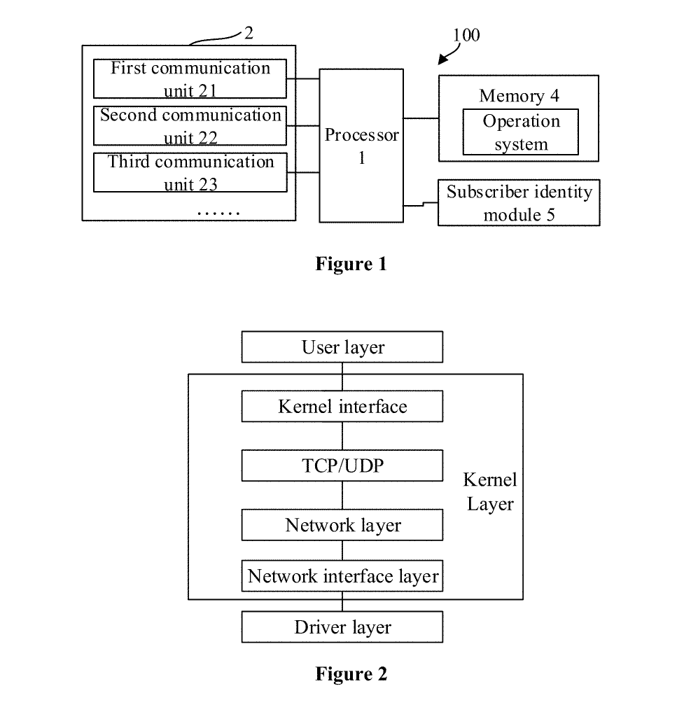

FIG. 1 illustrates a schematic structural diagram of a terminal consistent with one embodiment of the present invention. A terminal 100 may include any one of a variety of configurations including, for example, a personal computer (e.g., a laptop computer, a netbook computer, a tablet computer, etc.), a cellular phone, a personal digital assistant (PDA), a digital video recorder (DVR), an Internet appliance, a game console, and an electronic reader, etc. An architecture of the terminal 100 may include a processor 1, a communication unit 2, a memory 4, and a subscriber identity module 5. It should be understood that, in addition, the terminal 100 may further include: a display screen, a speaker, a headset, a camera, and power management, etc., for executing corresponding functions.

The memory 4 may store an operating system executed by the processor 1, and software programs for processing and controlling operations, etc. The memory 4 may include at least one type of storage medium, and the storage medium may include a flash memory, a hard disk, a multimedia card, a card type memory (e.g., SD or DX memory, etc.), a random-access memory (RAM), a static random-access memory (SRAM), a read only memory (ROM), an electrically erasable programmable read only memory (EEPROM), a programmable read only memory (PROM), a magnetic memory, a magnetic disk, and an optical disk, etc. In addition, the terminal 100 may cooperate with a network storage device that executes storage functions of the memory 4 through a network connection.

The processor 1 may be a core of the terminal communication function and system control, and may be mainly responsible for completing the work in two aspects. The first aspect is to include a capability of completing a baseband processing of a physical layer of a protocol stack, including digital joint detection, modulation/demodulation, interleaving/deinterleaving, channel coding/decoding, and pulse shaping, etc. The second aspect is to handle the operating system, driver software, a human-machine interface, and application programs, etc. At the same time, the processor may further have the ability to manage various peripherals and interfaces.

In one embodiment of the present invention, the communication unit 2 may generally include one or more components, and allow radio communication between the terminal 100 and a wireless communication system or network. For example, the communication unit 2 may include a first communication unit 21, and a second communication unit 22, etc. Optionally, the first communication unit 21 may be a WIFI unit. The WIFI unit may execute communication according to a WIFI protocol. Therefore, the terminal 100 in the disclosed embodiments of the present invention may perform data transmission through a WIFI network.

The second communication unit 22 may be a mobile communication unit. The mobile communication unit may be configured to transmit a communication exchange signal to one or more base stations or other devices in the wireless communication system, or to receive the communication exchange signal from one or more base stations or other devices. For example, the mobile communication unit 2 may include one or more of a transmitter, a receiver, transmit chain components, and receive chain components. In certain embodiments, the mobile communication unit 2 may be a chip that performs communication according to various communication standards, such as IEEE, Zigbee, 3G (third generation), 3GPP (third generation cooperation project), and LTE (long-term evolution). Therefore, the terminal 100 in the disclosed embodiments of the present invention may perform data transmission through a mobile communication network (e.g., 2G, 3G, 4G, or other mobile communication networks).

It should be understood that the communication unit 2 may further include a Bluetooth unit, and an NFC unit, etc., for implementing corresponding wireless communication functions.

The subscriber identity module 5 may manage users associated with a first technical standard. The subscriber identity module 5 may have one or more associated phone numbers. The terminal 100 may communicate in the network via the base stations through the subscriber identity module 5 and the mobile communication unit.

Optionally, the number of the subscriber identity modules 5 may be one or more. It should be understood that the number of the subscriber identity modules 5 may be related to the number of mobile communication units. For example, when the terminal 100 includes two mobile communication units, the terminal 100 may generally include two subscriber identity modules 5 to implement dual-card dual-standby. When the terminal 100 includes one mobile communication unit, the terminal 100 may include one (single-card single-standby) or two (dual-card single-standby) subscriber identity modules 5.

Referring to utility patent applications with application numbers 201510671407.1, 201510675596.X, and 201510827714.4, which describe technical solutions in detail for enabling the terminal to perform data transmission through dual LTE using different technical solutions, respectively. Based on the above three patent applications, the terminal 100 in the disclosed embodiments of the present invention may enable performing data transmission using one or two LTE data interfaces. It should be understood that dual LTE for data transmission may also be implemented in other manners, e.g., directly using a chip with such function, or using an external subscriber identity module, etc.

Based on the foregoing descriptions, the terminal 100 in the disclosed embodiments of the present invention may perform data transmission using at least one or more of the following manners: a WIFI data interface (the number of the WIFI data interfaces may be one or more), an LTE data interface (the number of the LTE data interfaces may be one or more), a 3G data interface (the number of the 3G data interfaces may be one or more), and a 2G data interface (the number of the 2G data interfaces may be one or more). It should be understood that, in certain cases, some data interfaces cannot coexist. For example, for a same one mobile communication unit, either the LTE data interface or the 3G data interface may be provided, while both of them may not be provided at the same time. However, for different mobile communication units, the LTE data interface and the 3G data interface may be respectively provided at the same time.

It should be understood that when the number of the WIFI data interfaces is more than one, the terminal 100 may include a plurality of WIFI units.

In one embodiment of the present invention, a plurality of operating systems may be stored in the memory 4. The operating system may include but not limited to Windows, Linux, Unix, Mac OS X, IOS, Solaris, and Android, etc.

Optionally, referring to FIG. 2, the architecture of the operating system stored in the memory 4 as shown in FIG. 1 and processed and executed by the processor 1 may include a driver layer, a kernel layer, and a user layer. Further, the kernel layer may include a network interface layer, a network layer, TCP/UDP, and a kernel interface.

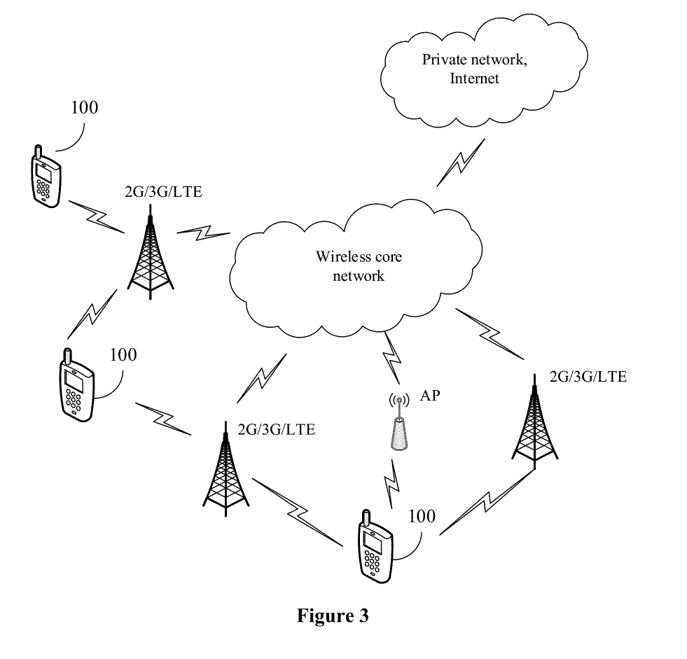

FIG. 3 illustrates a schematic diagram of a network architecture consistent with one embodiment of the present invention. The terminal 100 may be connected to a wireless core network simultaneously through a base station, a wireless access point (AP), etc., and then connected to a private network, or an Internet network to implement wireless data transmission. On the other hand, a plurality of terminals 100 may be connected to the wireless core network through the base station and the wireless access point to implement data transmission between each other.

### Embodiment 1

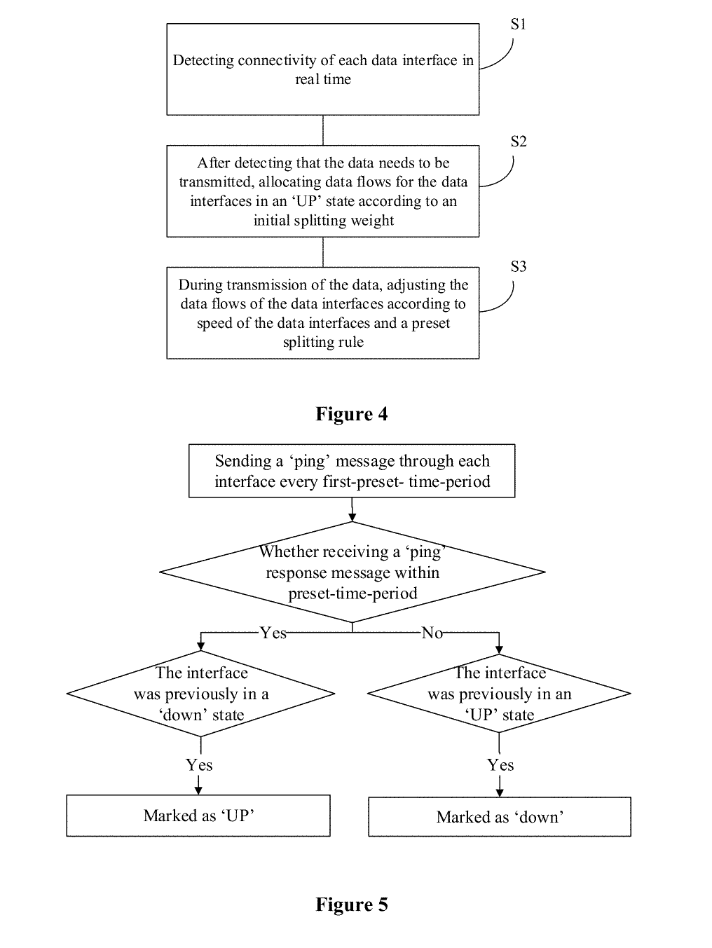

Referring to FIG. 4, the disclosed embodiments of the present invention provide a data-interface flow-splitting method. In one embodiment of the present invention, data to be transmitted may be divided into a plurality of data blocks. When the data needs to be transmitted, the plurality of data blocks may be transmitted through a plurality of established links, respectively. A terminal that has received the plurality of data blocks may then combine the plurality of data blocks to obtain the entire data. The data-interface flow-splitting method in the disclosed embodiments of the present invention may be to determine the size of data flow for each data interface, that is, to determine which data interfaces are used for transmission by the plurality of established links, respectively. Therefore, different data blocks may be transmitted through respective data interfaces, such that each data interface may be efficiently used, and the transmission efficiency may be improved. Optionally, the data-interface flow-splitting method in the disclosed embodiments of the present invention may include:

S1: Detecting connectivity of each data interface in real time. In one embodiment, the detection may be in real time. In a specific implementation, the detection may be in non-real time, e.g., a periodic detection, or a detection at a preset time interval.

It should be understood that detecting the connectivity of the interface may be detecting whether the data interface is connected. For example, detecting the connectivity of the WIFI interface may be detecting whether it is possible to access the WIFI network through the WIFI data interface for data transmission.

In one embodiment of the present invention, the interfaces may include a WIFI interface, an LTE interface, and a 3G interface, etc. The number of the interfaces may be more than one. For example, the interfaces may include two LTE interfaces and two WIFI interfaces.

Optionally, referring to FIG. 5, detecting connectivity of the interface may be performed in the following manner.

A ‘ping’ message may be sent from each interface every first-preset-time-period (e.g., 10 seconds). A destination IP address of the ‘ping’ may be an address of a fixed DNS server, e.g., 114.114.114.114.

After waiting for second-preset-time-period (e.g., 10 seconds), if a response is not received, the interface may be marked as ‘down’; and if a response is received, the interface may be marked as ‘UP’.

In certain embodiments, if the interface was previously in an ‘UP’ state and a response is not received after waiting for-preset-time-period, the interface may be marked as ‘down’. If the interface was previously in a ‘down’ state and a response is received after waiting for preset-time-period, the link may be considered to be connected, and the interface may be marked as ‘UP’.

Optionally, if an interface is in an ‘UP’ state, the interface may be added to a list of available interfaces. If an interface is in a ‘down’ state, the interface may not be added to the list of available interfaces or may be removed from the list of available interfaces.

It should be understood that detecting the connectivity of the interface may be performed by other manners, e.g., sending null data packet, etc.

S2: After detecting that the data needs to be transmitted, allocating data flow to the data interfaces in an ‘UP’ state according to an initial splitting weight.

In one embodiment of the present invention, after detecting that the data needs to be transmitted, the plurality of links may need to be established to transmit the plurality of data blocks. Establishing a link may be referred to establishing a link between a sending terminal device and a receiving terminal device. For example, the link may be established through a three-way handshake. The number of the links may be determined according to actual conditions, e.g., the maximum number of links that can be supported by the terminal 100, and the data size of the data job, etc.

In one embodiment of the present invention, the initial splitting weight may be a splitting weight of 1:1. That is, the established links may be allocated to the interfaces in an ‘UP’ state according to the splitting weight of 1:1.

Optionally, in one embodiment of the present invention, an initial routing rule may be established according to the connectivity of the interfaces. The initial routing rule may be established in an equally-dividing manner. That is, according to the initial splitting weight of 1:1, the number of links to be used for transmission allocated to the interfaces in the ‘UP’ state may be the same. For example, if both two interfaces are in an ‘UP’ state, the initial routing rule may be that the first, second, and third links transmit data through a first interface, and the fourth, fifth, and sixth links transmit data through a second interface.

In certain embodiments of the present invention, in response to transmitting the data, data transmission may be first performed according to the initial routing rule. Here, the data transmission may start from establishing the links. Optionally, in response to establishing the links, connection request messages may need to be generated, and the generated connection request messages may be equally allocated to each interface for transmission. The receiving terminal device may return a confirmation message for each connection request message after receiving the connection request message. The confirmation messages may be sent back to the sending terminal device via the corresponding interfaces, respectively. The sending terminal device may receive the confirmation messages and send acknowledgement messages through each interface to establish a plurality of TCP links between the sending terminal device and the receiving terminal device for data transmission. Unless otherwise specified, the plurality of links in the disclosed embodiments of the present invention may include one or more links.

It should be understood that in one embodiment of the present invention, after establishing the links between the sending terminal device and the receiving terminal device, data transmission may be performed. After a link completes its data transmission task (that is, the corresponding data block transmission is complete), the link may be released. Therefore, in one embodiment of the present invention, the links established at the beginning of the transmission may be allocated according to the initial routing rule. If the establishment of these links has completed the transmission of entire resources, it may be not necessary to establish a new link to continue transmission, otherwise new links may be established for the transmission of resources until the completion of the transmission of entire resources. The newly established links may be adjusted according to the flow-splitting method in S3.

S3: In the process of data transmission, adjusting data flow of each data interface according to speed of the data interfaces and a preset splitting rule.

Because network environments change in real time, the connectivity state, and speed, etc., of each interface may also change in real time. Therefore, during the transmission process of the data job, the data flow of each data interface may be adjusted according to the speed of interfaces and the preset splitting rule.

It should be understood that, in response to performing data transmission, the data job to be downloaded may be divided into a plurality of data blocks having a same size or different sizes to be transmitted through the plurality of established links, respectively. For example, a 10 M-sized APK may be divided into 10 data blocks, each data block may have a size of 1 M, and each data block may be transmitted via one link.

In certain embodiments, the maximum number of links that can be established by the terminal 100 may not be necessarily equal to the number of divided data blocks. For example, the number of data blocks may be 10, while the maximum number of established links may be 5. Then, after the transmission of a link is complete, correspondingly, a new link may be established to continue transmitting the remaining data. Optionally, in one embodiment of the present invention, after performing the flow-splitting according to the initial splitting weight in S2, the newly established links in the data transmission process may be allocated to different data interfaces according to the speed of the data interfaces and the preset splitting rule.

Optionally, the speed of the interface may be detected every first-preset-time-period (e.g., 1 second). In one embodiment of the present invention, the speed of the interface may be detected in the following manner.

A change in the number of bytes of the interface (interface bytes) may be obtained every preset-time-period (e.g., 1 second) as a current speed of the interface. Optionally, if the speed of an interface is detected for the first time, the number of detected bytes may be saved. If the speed of an interface is detected not for the first time, the number of obtained interface bytes may subtract the number of last time obtained interface bytes, and the obtained difference divided by time-period between the two detections may be the current speed of the interface.

In one embodiment of the present invention, the splitting weight may be determined according to the speed of the interfaces in the following manner.

The speed detection of the interface may be performed to detect whether the interface is in a congested state. If the interface is in a congested state, it may be determined that whether the current real-time speed is smaller than a previous statistical maximum speed (max_speed). If the current real-time speed is smaller, it may be determined that whether the current real-time speed added with a preset value (e.g., 100 KB/s) is smaller than the maximum speed (max_speed). If the current real-time speed added with the preset value is smaller, it may indicate that the network environments may have undergone a great transformation, and the current real-time speed may be assigned to the maximum speed (max_speed).

If the interface is not in a congested state and the current real-time speed is greater than the maximum speed (max_speed), the current real-time speed may be assigned to the maximum speed (max_speed).

In one embodiment of the present invention, in response to calculating the splitting weight according to the speed of the interfaces, the calculation may be performed according to the following formula:

A splitting weight of an i-th interface=a maximum speed of the i-th interface/(a maximum speed of a first interface+a maximum speed of a second interface+ . . . + the maximum speed of the i-th interface+ . . . ). It should be understood that the foregoing calculation of the splitting weight according to the speed of the interfaces may be performed in other manners. For example, a relationship between a speed range and the splitting weight may be set in advance. As the speed is in a first range, the splitting weight may be 20%, while as the speed is in a second range, the splitting weight may be 80%, etc.

In one embodiment of the present invention, detecting whether the interface is in a congested state may be obtained by detecting a delay of the interface. The method for detecting the delay of the interface may include the following two manners.

Manner 1: Sending a group of ‘ping’ messages (e.g., 5 messages per group, and 64 bytes per message) through the interface every preset-time-period (e.g., 5 seconds), and obtaining the delay of the interface according to a time difference of receiving the response.

Manner 2: Calculating the delay through the TCP three-way handshake.

Optionally, after receiving ‘syn+ack’ messages, it may be determined whether the system is in a ‘SYN_SEND’ state. If the system is in a ‘SYN_SEND’ state, a current system time may be obtained, and the current system time may subtract a time when the system sent the ‘syn’ message to obtain a time difference. The time difference may be the delay of the interface.

If the delay is greater than or equal to a preset value (e.g., 1000 ms), the interface may be marked as being in a congested state. If the delay is less than the preset value, it may be detected whether the ‘syn’ message of the link is re-transmitted. If the ‘syn’ message is re-transmitted, the interface may be marked as being in a congested state, and a delay value may be set as 1000 ms. If the ‘syn’ message is not re-transmitted, the interface may not be in a congested state.

Optionally, if a preset abnormal condition occurs, the splitting weight may be set to 1:1, that is, the flow-splitting may be performed by a default weight of 1:1. For example, the preset abnormal condition may include but not limited to the maximum speed not being greater than a preset value, etc.

The foregoing describes the specific implementation of adjusting the splitting weight according to the speed of the data interfaces to adjust the data flow of each data interface. While in one embodiment of the present invention, in response to adjusting the data flow of each data interface, the preset splitting rule may need to be considered.

In one embodiment of the present invention, the data interfaces may include one WIFI data interface and one LTE data interface. Because the WIFI data interface has the advantages of low cost and stable speed compared to the LTE data interface, when the WIFI data interface and the LTE data interface satisfy a certain speed and splitting weight relationship, the data flow of each data interface may be adjusted according to the preset splitting rule.

### Optionally:

When the speed of the WIFI data interface and the LTE data interface continue to be lower than a preset speed for preset-time-period, and the splitting weight of the WIFI data interface is greater than a first preset value or lower than a second preset value, the splitting weight of the WIFI data interface may be adjusted to the first preset value.

If a ratio of an average speed of the WIFI data interface over an overall average speed of the entire interfaces is greater than the first preset value, the splitting weight of the WIFI data interface may be adjusted to 1. If the ratio is less than the second preset value, the splitting weight of the WIFI data interface may be adjusted to 0. If the ratio is less than the first preset value or greater than the second preset value, the splitting weight of the WIFI data interface may be equal to the ratio.

In an optional embodiment, if the speed of the WIFI data interface and the LTE data interface continue to be lower than 3 Mbps for above 120 s, and the splitting weight of the WIFI data interface is greater than 0.7 or lower than 0.3, the splitting weight of the WIFI data interface may be set to 0.7. Otherwise, when both the average speed of the WIFI data interface and the LTE data interface are greater than 0, the ratio of the average speed of the WIFI data interface over the overall average speed may be calculated. When the ratio is greater than 0.7, the splitting weight of the WIFI data interface may be set to 1. If the ratio is less than 0.3, the splitting weight of the WIFI data interface may be set to 0. Otherwise, the splitting weight of the WIFI data interface may be set equal to the ratio.

Further, ratio=(wifi_avg)/(wifi_avg+LTE_avg), where wifi_avg represents the average speed of the WIFI data interface, and LTE_avg represents the average speed of the LTE data interface.

In one embodiment of the present invention, the average speed of the data interface may be calculated according to any one of the following manners.

Manner 1: The average speed of the data interface (avg)=old_avg×first weight+cur_speed×second weight, where old_avg represents an average value in a previous period, that is, a previous statistical average speed, and cur_speed represents the current real-time speed. In this way, the average speed of the data interface may be made smooth. When the speed of the interface has a large jump, the effect of such changes may be reduced, preventing instability during allocation. For example, if the speed of the interface suddenly increases at a certain moment, while decreases at the next moment, in this case, the current speed of the interface cannot reflect the actual speed of the interface. The calculation method in Manner 1 may make the splitting not change significantly to prevent “jitter” during allocation. In a preferred embodiment, the first weight may be 0.8, and the second weight may be 0.2.

Manner 2: The average speed of the data interface may be a ratio of a sum of the speed of the interface within preset-time-period over a length of the preset-time-period. The speed of the interface may be obtained according to the above method of detecting the speed of the interface.

Therefore, on the basis of the flow-splitting based on the splitting weight, the adjustment of data flow of each data interface may be further optimized, and the flow-splitting of the data interface may be optimized.

In one embodiment of the present invention, the newly established links in the data transmission process may be allocated to each interface for transmission of the data job according to the speed of the interfaces and the preset splitting rule. Therefore, in one embodiment of the present invention, a current routing rule may be re-established according to a real-time splitting weight. The difference between the current routing rule and the initial routing rule may include that, in the current routing rule, the established links may be allocated to each interface in an ‘UP’ state according to the speed of the interfaces and the preset splitting rule. Optionally, to ensure that the established links perform transmission through the corresponding interfaces according to the speed of the interfaces and the preset splitting rule, in one embodiment of the present invention, using the method of link data packet marking, the data packets of the links may be marked. Thus, during the transmission, different links may perform transmission through the corresponding interfaces according to mark values of the data packets.

Table 1 illustrates a routing rule formed after marking the data packets according to the speed of the interfaces and the preset splitting rule in one embodiment.

TABLE 1

| Links | Mark value | Interfaces |
|---|---|---|
| 1 | 0X01 | First interface (e.g., a WIFI |
| | | interface) |
| 2 | 0X02 | Second interface (e.g., a first LTE |
| | | interface) |
| 3 | 0X03 | Third interface (e.g., a second LTE |
| | | interface) |
| . . . | . . . | . . . |

The mark value in Table 1 may be the mark values of the data packets in each link. In one embodiment of the present invention, a first data packet of each link may be marked, and the following data packets may be transmitted through the interface that the first data packet uses.

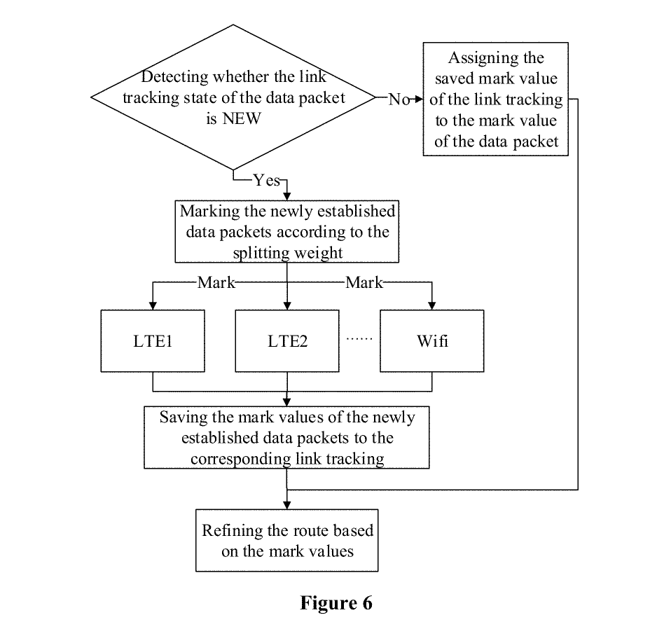

Optionally, referring to FIG. 6, when marking a data packet, the data packet may be first obtained, and it may be determined that whether the link tracking state of the data packet is a preset state. Here, the preset state may be a ‘New’ state, that is, whether it is a first data packet of a link.

If the link tracking state of the data packet is the preset state (that is, the data packet is the first data packet), the data packet may be marked according to the interface to which the link is allocated, and the mark value may be saved. Optionally, the mark value may be saved in a corresponding link tracking mark. If the link tracking state of a data packet is not the preset state (that is, the data packet is not the first data packet), the saved mark value of the first data packet of the link may be assigned to the data packet, and the data packet may be allocated to the corresponding interface for transmission according to the mark value of the data packet.

Therefore, the mark value of the data packet in the disclosed embodiments of the present invention may have double meanings: one is to determine the link to which the data packet belongs, and the other one is to determine which interface the data packet uses for transmission.

In one embodiment of the present invention, for a link that has been allocated to a corresponding interface, transmission may be performed through the interface until completion. However, if an interface in an ‘UP’ state becomes in a ‘down’ state during the transmission, the link for transmission through the interface may be suspended, and the data transmission of the link may be continued by establishing a new link. Optionally, for example, a size of a data that a link needs to transmit may be 1 M, after a 0.5 M-sized data is transmitted, the corresponding transmission interface may be interrupted abnormally. Such change may be reflected in the current routing rule, and the splitting weight may change. After establishing a new link, the new link may be allocated to the corresponding interface according to the current routing rule to continue the transmission of the remaining 0.5 M-sized data.

In one embodiment of the present invention, after the transmission of entire data jobs is complete, the interfaces may be closed, and the current routing rule may be deleted. For some needs, the routing rule may not be deleted. For example, the saved routing rule may be used for next data transmission.

In this case, the initially established links may be allocated according to the splitting weight of 1:1, and the newly established links may be allocated based on the speed of the interfaces and the preset splitting rule, which may improve the allocation efficiency and increase the interface utilization rate and the transmission speed.

After the data transmission is complete, the receiving terminal device may combine the data received through respective links to obtain the entire data resource.

Through the data-interface flow-splitting method in the disclosed embodiments of the present invention, a plurality of data interfaces may be simultaneously used to transmit data, which may greatly optimize the allocation ratio of the data flow. Because the speed may reflect a bandwidth size of the interface to a certain extent, the interface with a larger bandwidth may carry more data. Therefore, a large amount of data may not be likely to be transmitted through the interface with a small bandwidth, such that the issues of congestion of the interface with the small bandwidth, large delay, and packet loss may be avoided, improving user experience. Flow-splitting based on the speed of the interfaces and the preset splitting rule may optimize the allocation efficiency and improve data-interface utilization rate. At the same time, the setting of the preset splitting rule may allow the WIFI data interface to be preferentially used to save costs for users and to improve user experience.

### Embodiment 2

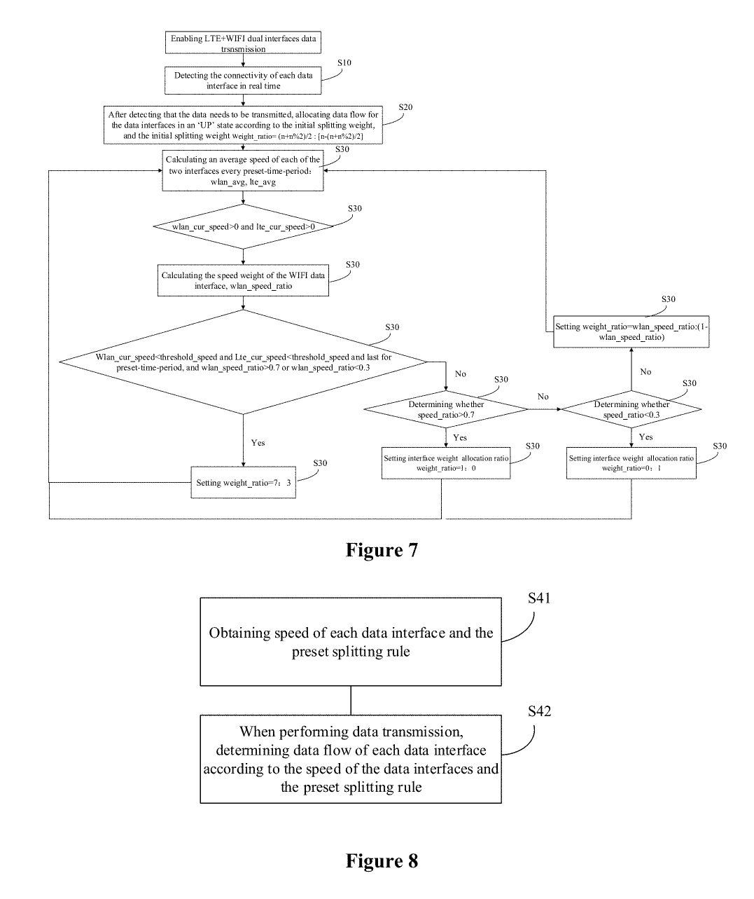

Referring to FIG. 7, the data-interface flow-splitting method in the disclosed embodiments of the present invention may include the following:

S10: Detecting the connectivity of each data interface in real time.

Optionally, as described above, the terminal 100 in the disclosed embodiments of the present invention may support at least two data interfaces for data transmission. In practical applications, the data interface may be enabled by controlling a data switch corresponding to the data interface. In some terminals 100, the data interfaces contained in the terminal may be enabled by default according to the corresponding functional lower layer framework through settings.

In one embodiment of the present invention, the data interfaces may include LTE data interfaces and WIFI data interfaces, and the two data interfaces may be enabled in the following manner. After the terminal 100 successfully connects to a WIFI hotspot, a time interval for sending “close request” may be set to an infinite length (e.g., 100 hours), such that the terminal 100 may not activate a PDP context of a card data service. Therefore, the data interface of the subscriber identity module may remain enabled. It should be understood that in the prior art, the “close request” may be a command for enabling the terminal to activate the PDP context of the card data service to disable card data interfaces. In the disclosed embodiments of the present invention, by not triggering the “close request” command, the card data interfaces may not be disabled such that both the WIFI data interfaces and the LTE data interfaces may be enabled.

Therefore, when the terminal 100 has a data job (e.g., downloading) that needs to be transmitted, the transmission of the data job to be transmitted between the terminal 100 and servers or other terminals may be performed using a plurality of data interfaces through following steps. The data job to be transmitted may include an APP application, a game, a web page, or a PS voice service, etc.

S20: After detecting that the data needs to be transmitted, allocating data flows for the data interfaces in an ‘UP’ state according to the initial splitting weight.

In one embodiment, the initial splitting weight may be obtained according to the following formula:

Q=(n+n%2)/2:[n−(n+n%2)/2],

where ‘Q’ is the initial splitting weight, and ‘n’ is the number of established links. ‘n %2’ represents taking the remainder of ‘n’ divided by 2, that is, if ‘n’ is divisible by 2, a value of ‘n %2’ is 0, otherwise the value of ‘n %2’ is 1. For example, if the number of the established links is four, then Q=1:1. That is, two links may be allocated to each of the WIFI data interface and the LTE data interface. If the number of the established links is five, then Q=3:2. That is, three links may be allocated to the WIFI data interface, and two links may be allocated to the LTE data interface. It should be understood that two links may be allocated to the WIFI data interface, and three links may be allocated to the LTE data interface.

S30: In the data transmission process, adjusting data flow of each data interface according to speed of the data interfaces and the preset splitting rule.

In one embodiment, the average speed of the WIFI data interface may be calculated as: wlan_avg=wlan_old_avg*0.8+wlan_cur_speed*0.2, where, wlan_avg represents the average speed of the WIFI data interface. In one embodiment of the present invention, the average speed of the data interface may be updated every preset-time-period (e.g., 1 second). Therefore, wlan_old_avg represents the last time average speed of the WIFI data interface, and wlan_cur_speed represents the current real-time speed of the WIFI data interface. The method for calculating the current real-time speed of the WIFI data interface may be obtained according to the manner in above Embodiment 1.

The average speed of the LTE data interface may be calculated as: lte_avg=lte_old_avg*0.8+lte_cur_speed*0.2, where, lte_avg represents the average speed of the LTE data interface. In one embodiment of the present invention, the average speed of the data interface may be updated every preset-time-period (e.g., 1 second). Therefore, lte_old_avg represents the last time average speed of the LTE data interface, and lte_cur_speed represents the current real-time speed of the LTE data interface. The method for calculating the current real-time speed of the LTE data interface may be obtained according to the manner in above Embodiment 1.

In one embodiment of the present invention, after allocating the data flow of each data interface according to the initial splitting weight, during the data transmission process, the allocation of the data flow may be adjusted according to the speed of the interfaces and the preset allocation rule. Optionally:

If the real-time speed of the WIFI data interface is greater than 0, and the real-time speed of the LTE data interface is also greater than 0, a speed weight of the WIFI data interface may be calculated as wlan_speed_ratio=wlan_avg/(wlan_avg+lte_avg), where wlan_avg and lte_avg may be calculated according to the foregoing methods.

If wlan_speed_ratio >0.7, the splitting weight allocation ratio (weight_ratio) of the WIFI data interface and the LTE data interface may be 1:0, that is, the entire data flow may be allocated to the WIFI data interface (the entire newly established links may perform transmission through the WIFI data interface).

If wlan_speed_ratio <0.3, the splitting weight allocation ratio (weight_ratio) of the WIFI data interface and the LTE data interface may be 0:1, that is, the entire data flow may be allocated to the LTE data interface (the entire newly established links may perform transmission through the LTE data interface).

If 0.3<wlan_speed_ratio <0.7, the splitting weight allocation ratio of the WIFI data interface and the LTE data interface weight_ratio=wlan_speed_ratio: (1−wlan_speed_ratio), and the newly established links may be allocated according to the weight_ratio.

If the detected real-time speed of the two data interfaces (wlan_cur_speed and lte_cur_speed) are lower than a preset threshold (e.g., 5 Mbps), and such a low-speed state lasts for a preset duration (e.g., 100 s), and wlan_speed_ratio >0.7 or wlan_speed_ratio <0.3, then weight_ratio=7:3 may be set, and the newly established links may be allocated according to the weight_ratio.

Therefore, through the data-interface flow-splitting method in the disclosed embodiments of the present invention, in a case where the speed (quality of links) of the two interfaces are similar, a dual-interface links-concurrency scheme may be adopted. The limited bandwidth resources of the dual interfaces may be fully utilized, and a bandwidth superposition may be performed, such that the high-quality interface may carry more data flow, and the low-quality interface may carry less data flow, which may save the time-period required for downloading or uploading. In a case where the speed (quality of links) of the two interfaces are significantly different, a dual-interface preferred scheme may be adopted. Under the condition that the transmission of thread resources allocated to the high-quality interface is complete, the data transmission through the low-quality links may be prevented from still being performed, and the overall data transmission efficiency may not be delayed. In a case where the qualities of the links of the two interfaces are poor, the concurrency transmission scheme may be forcibly enabled for the data transmission through the two interfaces, and the WIFI link may be used as much as possible to transmit the corresponding data to save the user's data usage.

It should be understood that Embodiment 1 and Embodiment 2 of the present invention may be combined with each other, and the implementation details described in above Embodiment 1 may be applicable to Embodiment 2.

Correspondingly, the disclosed embodiments of the present invention further provide a data-interface flow-splitting apparatus, including:

a detection unit configured to detect the connectivity of each data interface, where the detection unit may be configured to detect the connectivity in real time, or to detect the connectivity at a preset time interval;

an initial allocation unit configured to allocate data flows for the data interfaces in an ‘UP’ state according to the initial splitting weight after detecting that data needs to be transmitted; and

an adjustment unit configured to adjust data flow of each data interface according to the speed of the data interfaces and the preset splitting rule during a data transmission process.

It should be understood that the implementation principles and details of the data-interface flow-splitting method described above are applicable to the data-interface flow-splitting apparatus, which are not repeated herein. The detection unit, the initial allocation unit, and the adjustment unit herein may correspond to a processor or a processing circuit, and the processor or the processing circuit may perform the above operations by executing preset codes.

Correspondingly, the disclosed embodiments of the present invention further provide a terminal device, including:

a plurality of wireless data interfaces; and

a processor configured to detect the connectivity of each data interface in real time, to allocate data flows for the data interfaces in an ‘UP’ state according to the initial splitting weight after detecting that data needs to be transmitted, and to adjust data flow of each data interface according to the speed of the data interfaces and the preset splitting rule during a data transmission process.

The data interfaces may include one WIFI data interface and one LTE data interface.

The processor may include an application processor (AP), a central processing unit (CPU), a digital signal processor (DSP), or a field programmable gate array (FPGA), etc.

The preset splitting rule may include:

when the speed of both the WIFI data interface and the LTE data interface continue to be lower than a preset speed for preset-time-period, and the splitting weight of the WIFI data interface is greater than a first preset value or lower than a second preset value, the splitting weight of the WIFI data interface may be adjusted to the first preset value; and

when a ratio of an average speed of the WIFI data interface over an overall average speed of the entire interfaces is greater than the first preset value, the splitting weight of the WIFI data interface may be adjusted to 1; when the ratio is less than the second preset value, the splitting weight of the WIFI data interface may be adjusted to 0; and when the ratio is less than the first preset value or greater than the second preset value, the splitting weight of the WIFI data interface may be equal to the ratio.

It should be understood that the implementation principles and details of the data-interface flow-splitting method described above are applicable to the terminal device, which are not repeated herein.

The data-interface flow-splitting method, apparatus, and the terminal device in the disclosed embodiments of the present invention may simultaneously transmit data using the plurality of data interfaces, which may significantly optimize the allocation ratio of data flow. Because the speed may reflect a bandwidth size of the interface to a certain extent, the interface with a larger bandwidth may carry more data. Therefore, a large amount of data may not be likely to be transmitted through the interface with a small bandwidth, such that the issues of congestion of the interface with the small bandwidth, large delay, and packet loss may be avoided, improving user experience. Flow-splitting based on the speed of the interfaces and the preset splitting rule may optimize the allocation efficiency and improve data-interface utilization rate. At the same time, the setting of the preset splitting rule may allow the WIFI data interface to be preferentially used to save costs for users and to improve user experience.

Referring to FIG. 8, the disclosed embodiments of the present invention further provide another data-interface flow-splitting method, including:

S41: Obtaining speed of each data interface and the preset splitting rule; and

S42: When performing data transmission, determining data flow of each data interface according to the speed of the data interfaces and the preset splitting rule.

In S41, for example, the speed of the data interfaces in a data transmission state or in an ‘UP’ state (that is, a state capable of transmitting data) and the preset splitting rule may be obtained. Here, the speed may be a current transmission speed, or a maximum transmission speed. At the initial transmission moment, the speed may include the maximum transmission speed. At subsequent transmission moment following the initial transmission moment, the speed may include the current speed of the data interface and the maximum transmission speed.

In S42, data splitting may be performed according to the preset splitting rule and the speed of the interfaces. The data splitting herein may include determining the splitting weight. Once the splitting weight is determined, when the total data flow is a constant, the data that needs to be transmitted per unit time for each data interface may be determined. In the disclosed embodiments, through such adjustment, the phenomena that some interfaces are congested while some data interfaces are idle may be reduced.

In certain embodiments, the method may further include: obtaining the initial splitting weight of each data interface; and determining the data flow of each data interface at the initial moment of output transmission according to the initial splitting weight. Here, the initial splitting weight may be the aforementioned equally-dividing splitting weight of 1:1. However, a non-equally-dividing initial splitting weight may be set according to the difference between the maximum transmission speed of each data interface. For example, the maximum transmission speed of the WIFI interface may be ‘A’, and the maximum transmission speed of the LTE interface may be ‘B’. When ‘A’ is not equal to ‘B’, the initial splitting weight may be A:B. Therefore, the initial splitting weight may be non-equally-dividing splitting weight.

In certain embodiments, S42 may include: calculating a ratio of the current speed of the data interface over the maximum transmission speed of the data interface to obtain a loading ratio; and

according to the loading ratio, adjusting the splitting weight of each data interface to enable the transmission speed of each data interface to be less than the maximum transmission speed.

For example, according to the loading ratio, adjusting the splitting weight of each data interface may include:

reducing the splitting weight of the data interface having the loading ratio greater than an average loading ratio.

Each data interface may have a corresponding maximum transmission speed, and the current speed may be the current transmission speed of the data interface. In the disclosed embodiments, when performing the adjustment, the loading ratio may be calculated in combination with the maximum transmission speed and the current transmission speed. The loading ratio may generally be a positive number less than one.

In one embodiment, when the loading ratio of one data interface is greater than the average loading ratio of the entire data interfaces, the splitting weight of the one data interface may be reduced. Therefore, the loading balance of each data interface may be achieved, and the phenomena that some interfaces are congested while some data interfaces are idle may be avoided.

In certain embodiments, adjusting the splitting weight of each data interface according to the loading ratio may include: increasing the splitting weight of a data interface having a loading ratio less than the average loading ratio. The reduced data flow of the data interface may be transferred to another data interface having the loading ratio greater than the average loading ratio for transmission, to achieve the loading balance and to improve data transmission quality.

In certain embodiments, according to the loading ratio, adjusting the splitting weight of each data interface to enable the transmission speed of each data interface to be less than the maximum transmission speed may include: obtaining preset parameters for characterizing transmission priority of each data interface; determining adjustment thresholds according to the preset parameters, where the data interface with a different priority parameter may have a different adjustment threshold; obtaining a comparison result by comparing the loading ratio and the adjustment threshold; and adjusting the splitting weight of each data interface according to the comparison result.

The preset parameters may be directly set in the device priority, or may be other parameters.

For example, obtaining the preset parameters for characterizing transmission priority of each data interface may include obtaining interface-type parameters of each data interface. Determining the adjustment thresholds according to the preset parameters may include determining the adjustment thresholds according to the interface-type parameters. Adjusting the splitting weight of each data interface according to the comparison result may include when the loading ratio is greater than the adjustment threshold, reducing the splitting weight of the corresponding data interface. However, in practical applications, transmission stability of different data interfaces may be different. To ensure data transmission stability, the adjustment threshold of the data interface having higher transmission stability may be set higher.

Different interface types may have different transmission characteristics. For example, some interfaces may have low tariffs. Therefore, the adjustment threshold of the interface having lower tariff may be set higher. In this case, more data may be preferentially transmitted through the data interface having lower tariff.

In certain embodiments, obtaining the preset parameters for characterizing transmission priority of each data interface may include obtaining tariff parameters of each data interface. Determining the adjustment thresholds according to the preset parameters may include determining the adjustment thresholds according to the tariff parameters. Here, the adjustment may be made directly based on the tariff. For example, the tariff parameter representing the tariff per unit data flow may be inversely proportional to the adjustment threshold, such that the communication cost may be reduced as much as possible.

The disclosed embodiments of the present invention further provide a computer storage medium. Computer-executable instructions may be stored in the computer storage medium. The computer-executable instructions may be used in any one of the foregoing data-interface flow-splitting methods, e.g., the method shown in FIG. 1 or FIG. 8.

The computer storage medium may be an optical disk, a magnetic disk, or a variety of storage media, e.g., a DVD, a CD or a flash drive, etc. Optionally, the computer storage medium may be a non-transitory storage medium.

Any process or method description described in the flowcharts or described in other manners in the disclosed embodiments of the present invention may be understood as a unit, a segment, or a section of codes that includes one or more executable instructions for implementing steps of a specific logical function or process. The scope of the disclosed embodiments of the present invention may include additional implementations in which functions may be performed not in the order shown or discussed, and may be performed in a substantially simultaneous manner or in reverse order, depending on the functionality involved. This should be understood by those skilled in the art described in the disclosed embodiments of the present invention. In addition, in the description of the present invention, the meaning of ‘plurality’ is two or more unless otherwise specified.

The embodiments of the present invention have been described above with reference to the accompanying drawings. However, the present invention is not limited to the specific embodiments described above. Any modifications made according to the principles of the present invention should be understood as falling within the protection scope of the present invention.

1. A data-interface flow-splitting method, comprising:
detecting connectivity of each data interface;
after detecting that data needs to be transmitted, allocating data flows for data interfaces in an ‘UP’ state according to an initial splitting weight; and
during transmission of the data, adjusting the data flows of the data interfaces according to speed of the data interfaces and a preset splitting rule.

2. The method according to claim 1, wherein:
the initial splitting weight is 1:1.

3. The method according to claim 1, wherein:
the data interfaces include at least one WIFI data interface and at least one long-term evolution (LTE) data interface.

4. The method according to claim 3, wherein the preset splitting rule includes:
when speed of both the WIFI data interface and the LTE data interface continue to be lower than a preset speed for a preset time-period, and the splitting weight of the WIFI data interface is greater than a first preset value or lower than a second preset value, adjusting the splitting weight of the WIFI data interface to the first preset value.

5. The method according to claim 4, wherein the preset splitting rule further includes:
when a ratio of an average speed of the WIFI data interface over an overall average speed of the interfaces is greater than the first preset value, adjusting the splitting weight of the WIFI data interface to 1;
when the ratio is less than the second preset value, adjusting the splitting weight of the WIFI data interface to 0; and
when the ratio is less than the first preset value or greater than the second preset value, adjusting the splitting weight of the WIFI data interface to be equal to the ratio.

6. The method according to claim 5, wherein:
a change in a number of bytes of a data interface is obtained every preset-time-period as a speed of the data interface; and
an average speed of the data interface is a ratio of a sum of the speed of the data interface within preset-time-period over a length of the preset-time-period.

7. The method according to claim 5, wherein:
an average speed of the data interface is equal to a sum of a last time statistical average speed of the data interface multiplied by a first weight and a current speed of the data interface multiplied by a second weight.

8. (canceled)

9. A terminal device, comprising:
a plurality of wireless data interfaces; and
a processor, wherein the processor detects connectivity of each data interface, allocates data flows for data interfaces in an ‘UP’ state according to an initial splitting weight after detecting that data needs to be transmitted, and adjusts data flows of the data interfaces according to speed of the data interfaces and a preset splitting rule during transmission of the data.

10. The terminal device according to claim 9, wherein:
the data interfaces include one WIFI data interface and one LTE data interface; and
the preset splitting rule includes:
when speed of both the WIFI data interface and the LTE data interface continue to be lower than a preset speed for a preset time-period, and the splitting weight of the WIFI data interface is greater than a first preset value or lower than a second preset value, adjusting the splitting weight of the WIFI data interface to the first preset value;
when a ratio of an average speed of the WIFI data interface over an overall average speed of the interfaces is greater than the first preset value, adjusting the splitting weight of the WIFI data interface to 1;
when the ratio is less than the second preset value, adjusting the splitting weight of the WIFI data interface to 0; and
when the ratio is less than the first preset value or greater than the second preset value, adjusting the splitting weight of the WIFI data interface to be equal to the ratio.

11. The method according to claim 1, further comprising:
determining the data flows of the data interfaces at an initial transmission moment according to the initial splitting weight; and
in response to performing transmission of data, determining the data flows of the data interfaces according to the speed of the data interfaces and the preset splitting rule.

12. (canceled)

13. The method according to claim 11, wherein when performing transmission of the data, determining the data flows of the data interfaces according to the speed of the data interfaces and the preset splitting rule includes:
calculating a ratio of a current speed of a data interface over a maximum transmission speed of the data interface to obtain a loading ratio; and
according to the loading ratio, adjusting the splitting weight of each data interface to enable a transmission speed of each data interface to be less than the maximum transmission speed.

14. The method according to claim 13, wherein adjusting the splitting weight of each data interface according to the loading ratio includes:
reducing the splitting weight of a data interface having the loading ratio greater than an average loading ratio.

15. The method according to claim 14, wherein adjusting the splitting weight of each data interface according to the loading ratio includes:
increasing the splitting weight of a data interface having the loading ratio less than the average loading ratio.

16. The method according to claim 13, wherein according to the loading ratio, adjusting the splitting weight of each data interface to enable the transmission speed of each data interface to be less than the maximum transmission speed includes:
obtaining preset parameters for characterizing transmission priority of each data interface;
determining adjustment thresholds according to the preset parameters, wherein a data interface with a different priority parameter has a different adjustment threshold;
obtaining a comparison result by comparing the loading ratio and the adjustment threshold; and
adjusting the splitting weight of each data interface according to the comparison result.

17. The method according to claim 16, wherein:
obtaining the preset parameters for characterizing the transmission priority of each data interface includes:
obtaining interface-type parameters of each data interface;
determining the adjustment thresholds according to the preset parameters includes:
determining the adjustment thresholds according to the interface-type parameters; and
adjusting the splitting weight of each data interface according to the comparison result includes:
when the loading ratio is greater than the adjustment threshold, reducing the splitting weight of the corresponding data interface.

18. The method according to claim 16, wherein:
obtaining the preset parameters for characterizing the transmission priority of each data interface includes:
obtaining tariff parameters of each data interface; and
determining the adjustment thresholds according to the preset parameters includes:
determining the adjustment thresholds according to the tariff parameters.

19. The method according to claim 18, wherein:
a tariff parameter representing the tariff per unit data flow is inversely proportional to an adjustment threshold.

20. A non-transitory computer-readable storage medium, having computer-executable instructions stored thereon, wherein, when being executed, the computer-executable instructions cause a processor to perform a data-interface flow-splitting method, the method comprising:
detecting connectivity of each data interface;
after detecting that data needs to be transmitted, allocating data flows for data interfaces in an ‘UP’ state according to an initial splitting weight; and
during transmission of the data, adjusting the data flows of the data interfaces according to speed of the data interfaces and a preset splitting rule.

21. The medium according to claim 20, wherein:
the initial splitting weight is 1:1.

22. The medium according to claim 20, wherein:
the data interfaces include at least one WIFI data interface and at least one long-term evolution (LTE) data interface.
